(19) United States
(12) Patent Application Publication
(10) Pub. No.: US 2006/0213699 A1
(43) Pub. Date: Sep. 28, 2006

(54) Method for driving wheel-chair

(76) Inventor: Mei-Ying Lin, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 11/385,816

(22) Filed: Mar. 22, 2006

(30) Foreign Application Priority Data
Mar. 25, 2005 (TW) 094109397

(51) Int. Cl. B62D 11/02

(52) U.S. Cl. 180/6.5; 180/65.1

(57) ABSTRACT

A wheel-chair is easily controlled to move and turn by a left large wheel and a right large wheel. The large wheels have different rolling speeds, such as a full speed and a reduced speed, and different rolling directions, such as rolling forward and rolling backward.

### FIELD OF THE INVENTION

The present invention relates to a wheel-chair; more particularly, relates to easily controlling the wheel-chair to move and to turn through a simple electrical mechanism.

### DESCRIPTION OF THE RELATED ARTS

A prior art is disclosed in a U.S. Pat. No. 6,615,937, named “Motorized wheelchairs”. When an electrical control system of an electrical wheel-chair received a signal of turning, an angular rate of turn sensor is used and the signal of turning received is responded to the electrical control system to inform the accomplishing of turning the required angle to stop turning. This design is a close loop control, which makes the design more complex with easy breakdown and the cost becomes higher owing to the high-price sensor.

Another prior art is proclaimed in Taiwan, where a steering wheel is installed to an electrical wheel-chair to control the turning. But the steering wheel takes space and its installation is not easy, which is not suitable to a wheel-chair for child use. Hence, the prior arts do not fulfill users' requests on actual use.

### SUMMARY OF THE INVENTION

The main purpose of the present invention is to easily control a wheel-chair to move and to turn through a simple electrical mechanism.

To achieve the above purpose, the present invention is a method for driving a wheel-chair, where a wheel-chair is equipped with motors on a first and a second large wheels separately; by rotating output shafts of the motors under separated velocities and directions, the first and the second large wheels are rolled with different velocities and directions; and, consequently, on a ground level (X-Y plane), the wheel-chair precisely performs controlled movements, consisting of moving forward, moving backward, turning left, turning right, moving left forward, moving right forward, moving left backward and moving right backward.

### BRIEF DESCRIPTION OF THE DRAWINGS

The present invention will be better understood from the following detailed description of the preferred embodiment according to the present invention, taken in conjunction with the accompanying drawings, in which

FIG. 1 is a perspective view showing a preferred embodiment according to the present invention; and

FIG. 2 is a block view showing the control flow of the preferred embodiment.

### DESCRIPTION OF THE PREFERRED EMBODIMENT

The following description of the preferred embodiment is provided to understand the features and the structures of the present invention.

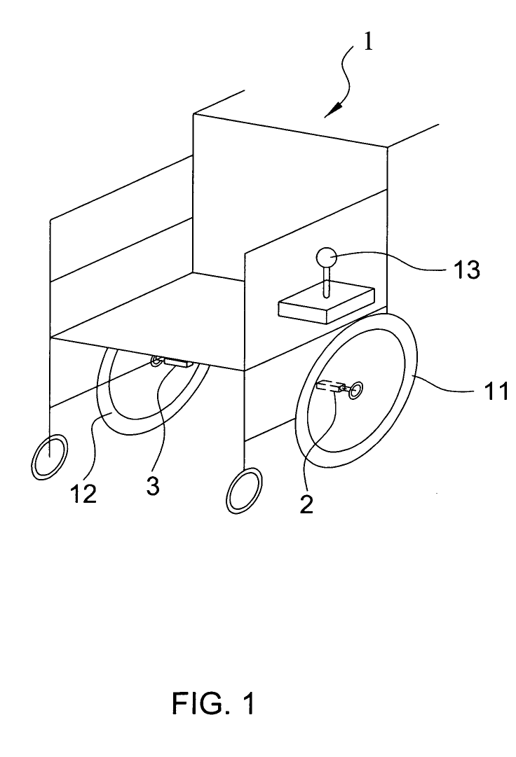

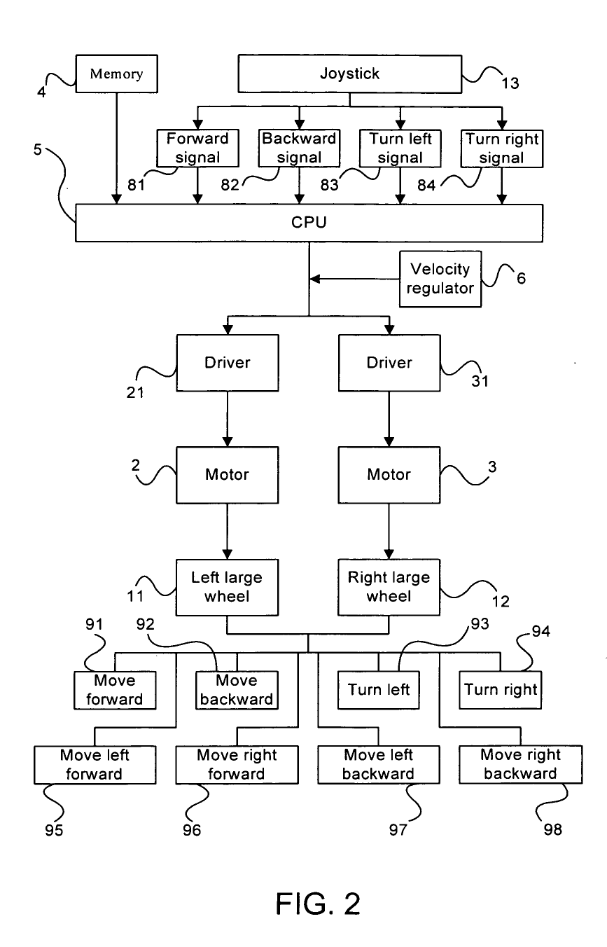

Please refer to FIG. 1 and FIG. 2, which are a perspective view showing a preferred embodiment according to the present invention and a block view showing the control flow. As shown in the figures, the present invention is a method for driving a wheel-chair. In the present invention, a wheel-chair is equipped with motors 2,3, which uses direct currents, on a first and a second large wheels 11,12 separately. By rotating output shafts of the motors 2,3 on the first and the second large wheels 11,12 under separated velocities and directions, the first and the second large wheels 11,12 are rolled with different velocities and directions so that, on a ground level (X-Y plane), the wheel-chair precisely performs controlled movements, consisting of moving forward 91, moving backward 92, turning left 93, turning right 94, moving left forward 95, moving right forward 96, moving left backward 97 and moving right backward 98. The logics and algorithms of the defined and regulated movements for the present invention is coded with a software into a controlling program; and the controlling program is stored in a system memory 4 of an electrical control system of the wheel-chair 1. The system memory 4 is an Electrically Erasable Programmable Read-Only Memory (EEPROM), a built-in memory of a microprocessor, or a flash disk; and is built in the electrical control system of the wheel-chair 1. A microprocessor is used as a central processing unit (CPU) in the electrical control system. The microprocessor is a Field Programmable Gate-Array (FPGA), a Reduced Instruction Set Computing (RISC) processor, a Complex Instruction Set Computing (CISC) processor or a Digital Signal Processor (DSP). The CPU 5 receives signals of moving and/or turning triggered by the driving-control joystick 13. If the signal received is a signal of moving forward 81, moving backward 82, turning left 83 or turning right 84, only a single of moving or turning is included; and the wheel-chair 1 moves or turns toward a direction only. If the driving-control joystick 13 triggers to make the wheel-chair 1 move left forward 95, move right forward 96, move left backward 97 or move right backward 98, two signals of moving or turning are included. That is, moving left forward 95 involves signals of moving forward 81 and turning left 83; moving right forward 96 involves signals of moving forward 81 and turning right 84; moving left backward 97 involves signals of moving backward 82 and turning left 83; and, moving right backward 98 involves signals of moving backward 82 and turning right 84. At the moment, not only the wheel-chair 1 moves toward the direction triggered; but also the two signals of moving or turning is processed through said logics and algorithms of said controlling program stored in the system memory 4 to figure out correct rotating velocities (selected from a certain velocity and a reduced velocity) and directions (selected from a forward direction and a reverse direction) for the output shafts of the motors 2,3 on the first and the second large wheels 11,12 of the wheel-chair 1. Then, with different coordinated rolling velocities and directions of the first and the second large wheels 11,12, the wheel-chair 1 precisely performs eight movements on a ground level (X-Y plane), which are moving forward 91, moving backward 92, turning left 93, turning right 94, moving left forward 95, moving right forward 96, moving left backward 97 and moving right backward 98.

In the other hand, the moving velocity of the wheel-chair 1 can be adjusted according to actual requirements. After inputting a signal of moving and/or turning through the driving-control joystick 13, the signal of moving and/or turning is received by the electrical control system of the wheel-chair 1 and the signal is processed through the logics and algorithms of the controlling program to figure out correct analog commands of voltage for velocity regulating adjusted with an input from the velocity regulator 6. Then, the commands are transferred to drivers 21,31 of the motors 2,3 on the first and the second large wheels 11,12 of the wheel-chair 1. The drivers 21,31 amplifies the commands in the drivers 21,31 for analog command of voltage. Then the motors 2,3 on the first and the second large wheels 11,12 of the wheel-chair 1 are driven by the amplified power so that controlled movements in the controlling program can be performed by the wheel-chair 1 through the first and the second large wheels 11,12.

Hence, the controlled movements are performed by the first and the second large wheels 11,12 driven by the motors with the rotating velocities and directions. Therein, please refer to FIG. 2, the controlled movements include:

(i) moving forward 91 by the first and the second large wheels 11,12 both under the certain velocity of a forward rolling;

(ii) moving backward 92 by the first and the second large wheels 11,12 both under the certain velocity of a backward rolling;

(iii) turning left 93 by the first large wheel 11 under the certain velocity of the backward rolling and the right large wheel 12 under the certain velocity of the forward rolling;

(iv) turning right 94 by the first large wheel 11 under the certain velocity of the forward rolling and the right large wheel 12 under the certain velocity of the backward rolling

(v) moving left forward 95 by the first large wheel 11 under the reduced velocity of the forward rolling and the right large wheel 12 under the certain velocity of the forward rolling;

(vi) moving right forward 96 by the first large wheel 11 under the certain velocity of the forward rolling and the right large wheel 12 under the reduced velocity of the forward rolling;

(vii) moving left backward 97 by the first large wheel 11 under the reduced velocity of the backward rolling and the right large wheel 12 under the certain velocity of the backward rolling; and

(viii) moving right backward 98 by the first large wheel 11 under the certain velocity of the backward rolling and the right large wheel 12 under the reduced velocity of the backward rolling.

Moreover, the certain velocity is adjustable to be set between 10 percents (%) to 100% of a full velocity output of the motor according to an actual requirement. As the like, the reduced velocity is adjustable to be set between 1% to 99% of the full velocity output of the motor. Thus, a novel method for driving a wheel-chair is obtained.

To sum up, the present invention is a method for driving a wheel-chair, where the wheel-chair can be easily controlled to move and to turn through a simple electrical mechanism.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for driving a wheel-chair, comprising steps of:
(a) deposing a first motor on a first large wheel of a wheel-chair and a second motor on a second large wheel of said wheel-chair;
(b) by using a first output shaft of said first motor rotating under a certain velocity in a first direction and a second output shaft of said second motor rotating under said certain velocity in a second direction, making said first large wheel and said second large wheel to roll under said certain velocity, each of said first direction and said second direction being selected from a group consisting of a forward direction and a reverse direction, each of said rolling of said first large wheel and said rolling of said second large wheel being selected from a group consisting of a forward rolling and a backward rolling, said forward rolling being driven by said rotating in said forward direction, said backward rolling being driven by said rotating in said reverse direction; and
(c) moving and/or turning said wheel-chair through said rolling of said first large wheel and said rolling of said second large wheel, said moving and/or turning of said wheel-chair comprising controlled movements of:
(i) moving forward by said first large wheel and said second large wheel both under said certain velocity of a forward rolling;
(ii) moving backward by said first large wheel and said second large wheel both under said certain velocity of a backward rolling;
(iii) turning left by said first large wheel under said certain velocity of a backward rolling and said second large wheel under said certain velocity of a forward rolling;
(iv) turning right by said first large wheel under said certain velocity of a forward rolling, and said second large wheel under said certain velocity of a backward rolling,
wherein said wheel-chair has an electrical control system; and
wherein said electrical control system has a central processing unit (CPU).

2. The method according to claim 1,
wherein said controlling program has logics and algorithms of said controlled movements.

3. The method according to claim 1,
wherein, between step (a) and step (b), said method further comprises steps of:
(d) receiving a signal of moving and/or turning with said CPU;
(e) processing said signal of moving and/or turning through said controlling program; and
(f) figuring out said first direction of said first output shaft and said second direction of said second output shaft.

4. The method according to claim 3,
wherein, after step (f), said method further comprises steps of adjusting said first velocity and said second velocity with an input of a velocity from a velocity regulator.

5. The method according to claim 1,
wherein said wheel-chair is deposed with a driving-control joystick to generate a signal of moving and/or turning to control said wheel-chair for moving and/or turning.

6. The method according to claim 1,
wherein a controlling program is stored in a memory selected from a group consisting of a One Time Programmable ROM (OTPROM) and a Electrically Erasable Programmable ROM (EEPROM) and a flash disk and a build-in memory of said CPU.

7. The method according to claim 1,
wherein said CPU is selected from a group consisting of a Reduced Instruction Set Computing (RISC) Processor, a Field Programmable Gate-Array Processor(FPGA) processor, a Complex instruction Set Computing (CISC) processor and a Digital Signal Processor (DSP).

8. The method according to claim 1,
wherein said certain velocity is set between 10 percents (%) to 100% of a full velocity output of a motor selected from a group consisting of said first motor and said second motor.

9. A method for driving a wheel-chair, comprising steps of:
(a) deposing a first motor on a first large wheel of a wheel-chair and a second motor on a second large wheel of said wheel-chair;
(b) by using a first output shaft of said first motor rotating under a first velocity in a first direction and a second output shaft of said second motor rotating under a second velocity in a second direction, making said first large wheel and said second large wheel to roll under said first velocity and said second velocity respectively, each of said first velocity and said second velocity being selected from a group consisting of a certain velocity and a reduced velocity, each of said first direction and said second direction being selected from a group consisting of a forward direction and a reverse direction, said rolling of said first large wheel and said rolling of said second large wheel being selected from a group consisting of a forward rolling and a backward rolling, said forward rolling being driven by said rotating in said forward direction, said backward rolling being driven by said rotating in said reverse direction; and
(c) moving and/or turning said wheel-chair by said rolling of said first large wheel and said rolling of said second large wheel, said moving and/or turning of said wheel-chair comprising controlled movements of:
(i) moving left forward by said first large wheel under said reduced velocity of said forward rolling and said second large wheel under said certain velocity of said forward rolling;
(ii) moving right forward by said first large wheel under said certain velocity of said forward rolling and said second large wheel under said reduced velocity of said forward rolling;
(iii) moving left backward by said first large wheel under said reduced velocity of said backward rolling and said second large wheel under said certain velocity of said backward rolling; and
(iv) moving right backward by said first large wheel under said certain velocity of said backward rolling and said second large wheel under said reduced velocity of said backward rolling,
wherein said wheel-chair has an electrical control system; and
wherein said electrical control system has a CPU.

10. The method according to claim 9,
wherein said controlling program has logics and algorithms of said controlled movements.

11. The method according to claim 9,
wherein, between step (a) and step (b), said method further comprises steps of:
(d) receiving a signal of moving and/or turning with said CPU;
(e) processing said signal of moving and/or turning through said controlling program; and
(f) figuring out said first direction and said first velocity of said first output shaft and said second direction and said second velocity of said second output shaft.

12. The method according to claim 11, wherein, after step (f), said method further comprises steps of adjusting said first velocity and said second velocity with an input of a velocity from a velocity regulator.

13. The method according to claim 9, wherein said wheel-chair is deposed with a driving-control joystick to generate a signal of moving and/or turning to control said wheel-chair for moving and/or turning.

14. The method according to claim 9,
wherein a controlling program is stored in a memory selected from a group consisting of a One Time Programmable ROM (OTPROM) and a Electrically Erasable Programmable ROM (EEPROM) and a flash disk and a build-in memory of said CPU.

15. The method according to claim 9
wherein said CPU is a microprocessor selected from a group consisting of a FPGA, a RISC Processor, a CISC processor and a DSP.

16. The method according to claim 9,
wherein said certain velocity is set between 10% to 100% of a full velocity output of a motor selected from a group consisting of said first motor and said second motor.

17. The method according to claim 9,
wherein said reduced velocity is set between 1% to 99% of a full velocity output of a motor selected from a group consisting of said first motor and said second motor.
